(19) United States
(12) Patent Application Publication
(10) Pub. No.: US 2017/0370758 A1
(43) Pub. Date: Dec. 28, 2017

(54) FLUID-LEVEL MEASURING SENSOR

(71) Applicant: Belite Enterprises LLC, Wichita, KS (US)

(72) Inventor: James P. Wiebe, Wichita, KS (US)

(21) Appl. No.: 15/657,000

(22) Filed: Jul. 21, 2017

Related U.S. Application Data
(63) Continuation of application No. 14/555,485, filed on Nov. 26, 2014, now abandoned.
(60) Provisional application No. 61/909,254, filed on Nov. 26, 2013.

(51) Int. Cl. G01F 23/14; G01F 25/00; G01F 22/00; G01F 23/18; G01L 27/00; G01L 7/18

(52) U.S. Cl. CPC G01F 23/14; G01L 27/007; G01L 7/187; G01F 22/00; G01F 23/185; G01F 25/0061

(57) ABSTRACT

A pressure sensor system for determining fluid level in a tank, includes a pressure sensor constructed to exhibit a force value corresponding to a sensed force, and a computer operatively coupled to the pressure sensor. A tank containing fluid is also includes and there is a communication link between the pressure sensor and the tank, thereby allowing determination of the level of fluid in the tank by calibration and interpretation of the force value exhibited by the pressure sensor.

### CROSS-REFERENCES TO PRIORITY APPLICATIONS

This application is a continuation of U.S. patent application Ser. No. 14/555,485, filed Nov. 26, 2014, which application claims the benefit under 35 U.S.C. §119(e) of U.S. Provisional Patent Application Ser. No. 61/909,254, filed Nov. 26, 2013, each of which are incorporated herein by reference in their entirety for all purposes.

### FIELD OF THE INVENTION

The present invention is a methodology for measuring the amount of fluid or fuel contained within a tank or enclosure. It also provides the capability of alerting the operator of certain error or contamination conditions, such as miss-fueling a gasoline fuel tank with jet fuel.

### BACKGROUND

Fuel levels are usually determined through the usage of a potentiometer, whose swing arm is mounted on a movable float. The float resides at the current surface of the fluid level, thus providing a comparative resistive indication proportional to the fluid level. The resistive indication is easily converted to a voltage or current level through the use of an external voltage or current source, then is sampled by direct display on an instrument, or by connection to a microprocessor for display on a screen or other display device.

Fuel levels are also determined through the use of a capacitive sender, which is usually created through the usage of a tube and an inner conductor, which do not touch each other. The dielectric between the two, normally being air when the tank or enclosure is empty, varies as liquid is introduced, because the dielectric constant of liquid, especially non-aqueous solutions such as gasoline, varies the capacitance of the probe as the liquid level rises within the tube.

Fuel levels may also be sensed by a pressure sensor, which provides a value proportional to the level of fluid above the sensor. In such cases the pressure sensor are either inserted in the bottom of the tank, or suspended via a harness holder and electrical wires from the top of tank to the bottom of the tank.

### SUMMARY

In one embodiment of the present invention, a pressure sensor is used, in conjunction with a microprocessor, appropriate software, appropriate display, and a force sensor, thus allowing the following features:
1) The general level of the liquid within the tank may be determined by calibration and interpretation of the force value from the pressure sensor.
2) If appropriately calibrated, the microprocessor may alert to an error condition of incorrect fluid type under certain conditions. For instance, if the fluid type is aviation gasoline, with a weight of 6.0 pounds per gallon, and the tank is mistakenly fueled with jet fuel, with a weight of 6.8 pounds per gallon, the sensor will provide a value, at full tank condition, of 113% of fuel load. (Jet fuel weighs 13% more than aviation gasoline, and the sensor is calibrated to weight.) This condition (or any condition showing more than 100% of full load) would cause the microprocessor algorithm to trigger an alarm, advising the vehicle operator to check the type of fluid within the tank. Alternatively, it could be used to automatically cause or force the fuel source to the engine to be changed to an alternate tank.

Conversely, an engine which uses jet fuel, at full tank condition, would only show 87% of the expected weight load, also providing the microprocessor opportunity to trigger a caution warning, especially if the tank had a top level trigger.
3) Appropriate calibration of large, flat tanks may require the use of a multiplicity of separate sensors at various parts or corners of the tank, this condition not being different than most capacitive or resistive sensors. This addition would allow resolution (especially in conjunction with a tilt sensor) of non-level sensing conditions.
4) Nothing precludes the use of additional calibration methodologies so that any size or shape of tank may be appropriately calibrated. As an example, many tanks have odd shapes to accommodate structural elements or design constraints of a vehicle containing the tank. The ratio of force per unit of height and volume does not need to be linear.
5) The usage of an accelerometer allows the microprocessor to more correctly determine the fluid level when the vehicle is operating in a manner which accelerates the fluid contents of the tank beyond the normal force of gravity. An example of this is when the airplane is flying in a coordinated turn at a banked angle. As a further example, a 60 degree bank angle will cause the force experienced to be exactly twice the normal force for the same fluid in level flight.
6) The usage of an electrical filter on the continuous pressure sensor signal allows short term perturbations to be smoothed with an appropriate time constant.

### BRIEF DESCRIPTION OF THE DRAWINGS

FIG. 1 shows a sensor which is used to sample the level of fluid in a tank or enclosure.

FIG. 2 shows a typical cross section of a tank or fuel enclosure that also includes the sensor of the present invention.

FIG. 3 shows a flow chart of a processor which is attached to the sensor in FIG. 2.

FIG. 4 shows a picture of a typical fluid or fuel gauge, which contains a microprocessor and connector for attachment to a fluid sensor.

### DETAILED DESCRIPTION

The present invention provides a method to determine fluid level and provide a warning of improper fueling conditions.

10) Fluid level sensor: Usually constructed from a stainless steel body with an embedded strain sensor, which is impervious to most fluid types. It is powered from a voltage source, usually five volts and ground differential, and provides an output which is generally linear to pressure. The output may be a voltage level or current level, for example, a level of 0.5 to 4.5 volts; with values therein proportional to force on the sensor, from empty to 100% of calibrated level. The calibrated level does not need to use the full scale of the device. For instance, an empty condition might be 0.5 volts and a full condition might be 1.0 volts. This would allow an improper filling to show a value slightly greater than 1.0 volts. The system may use a single or a multiplicity of fluid level sensors per tank.

12) Microprocessor: The microprocessor accepts the condition from the fluid sensor and interprets, via a software implementation similar to the flowchart, the current level of the fluid within the tank.

14) Display Device: The microprocessor commands the display device to show the current level of fluid within the tank or enclosure. For instance, a fluid level of 50% volume would produce an indication of 50% via an LED display, or an LCD display, or an analog (needle style) display, or any type of display or indicator which allows the operator to see or hear the fluid level.

16) Alarm: The microprocessor commands an alarm which shows a mis-fueled condition or other alarm condition. In the simplest example, this would include an incorrect fluid type, which is detected via an algorithmic determination that too many pounds of fluid are in the tank, given a known fluid type and given a known tank volume. In other examples, the alarm could be triggered at critical fuel levels, preset by the operator.

18) Accelerometer: This device is a requirement of this methodology, as it provides the ability to determine correct fluid level in accelerated (turning) conditions. The accelerometer may be in the fluid level sensor, or in the microprocessor circuitry.

20) Slosh filter: This may be implemented in an electrical form within the microprocessor control circuitry, or in software within the microprocessor firmware.

22) Full Fuel Switch: The operator may provide indication to the fueling computer system that a full fueling has been performed. This can be used to determine if a mis-fueled condition exists, for instance: a fuel load of 87% when the correct fuel load should be 100%. This would be the case if a jet fuel vehicle was miss-fueled with gasoline; any such value less than 100% would indicate a possible miss-fueling error.

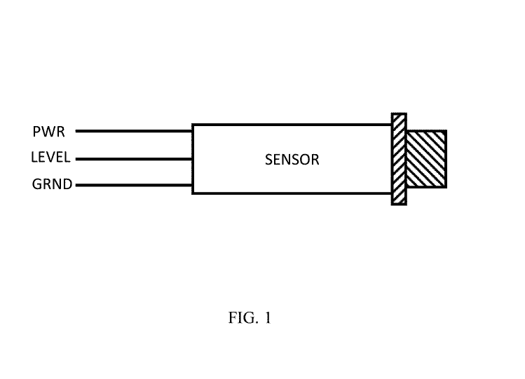

Referring to FIG. 1, a sensor is shown that is constructed to sample the level of fluid in a tank or enclosure. The sensor is typically constructed from a metal such as stainless steel, so that various fluid types will not corrode the sensor. The sensor has an opening on one end which allows fluid pressure to enter the sensor; while the other end typically has electrical connections for power, ground, and signal level out, which is an electrical value which is proportional to fluid height.

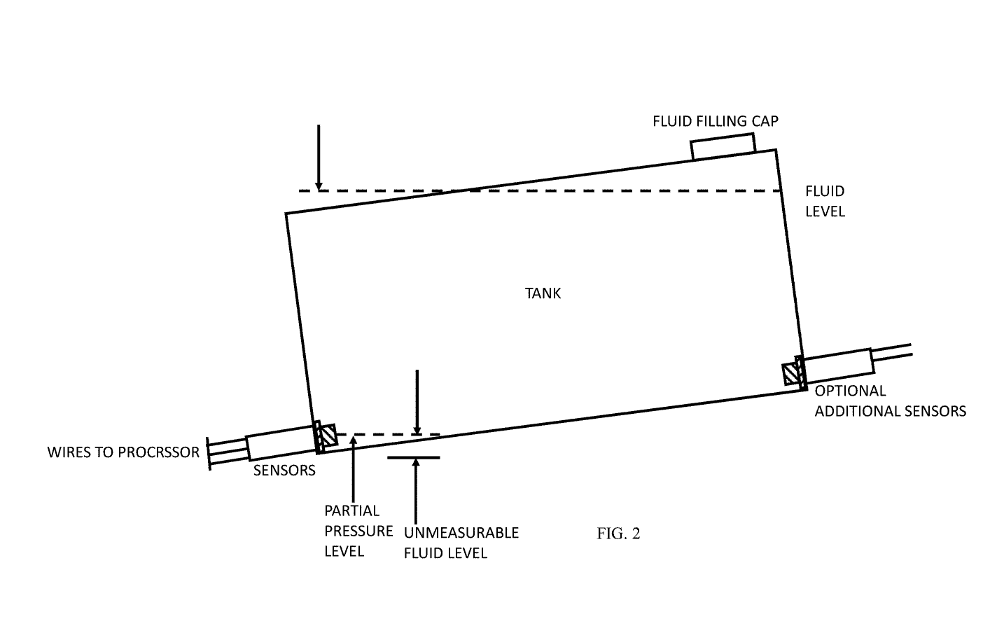

FIG. 2 shows a typical cross section of a tank or fuel enclosure, complete with an attached sensor, an optional secondary or tertiary sensor, a fluid level, an unmeasurable fluid level, a measured fluid height, and a method for entering fluid into the tank. Also shown is the tilt or cant of the tank or enclosure such that the level of the fluid is not proportional to the volume of fluid contained at that level in the tank.

Note that the undetectable fuel level may be zero, if the sensor is located at the zero point of the absolute bottom fuel level. While the tank shown is rectangular and canted, any type of tank shape or volume may be accommodated by determination of the fluid pressure at a particular fluid level. The tank may be completely irregular, or cubic, or spheroid, or any other shape which allows continuous flow of the fluid to the tank exit.

It is assumed that the fluid exits the tank at a low point of the tank, similar to, if not identical to (parallel), the position of the fluid level sensor.

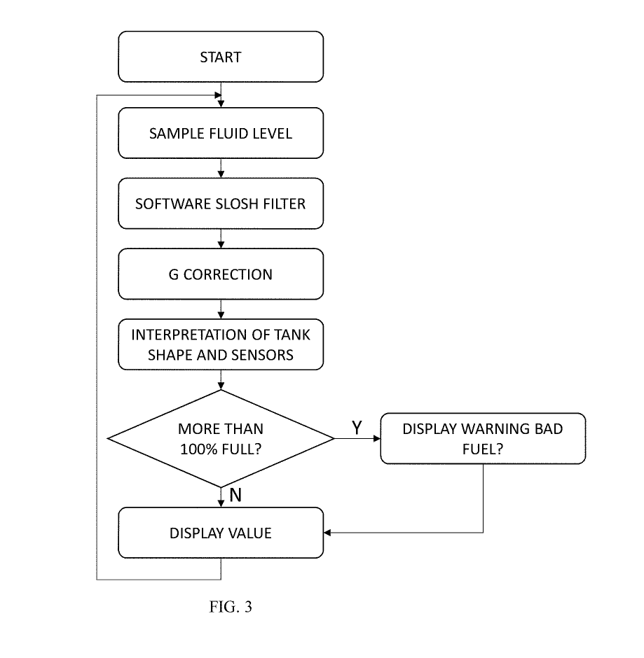

Referring to FIG. 3 there is a flow chart of a processor which is attached to the sensor. The microprocessor is responsible for sampling the sensor, applying a slosh filter (if required), applying a G compensation value (if required), interpolating multiple sensors and calculating a current fluid level, determining if an error level exists (such as over 100% fuel load), and displaying the resulting value on a fluid gauge of any type:

analog, LED, digital, LCD or other.

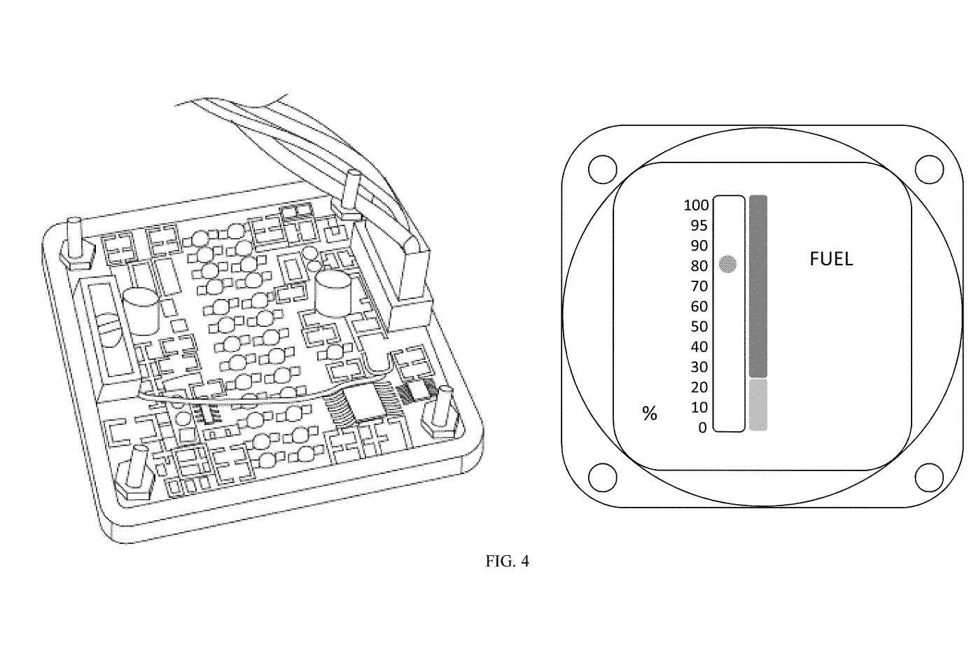

FIG. 4 shows a picture of a typical fluid or fuel gauge, which contains a microprocessor and connector for attachment to a fluid sensor. That figure also shows a circuit board which contains an electrical connector, which connects to a fluid sensor and also provides power, and also embeds a series of LED's for showing the percentage level of fluid (or fuel) within the tank. Not shown is an Alarm indication or the integrated G accelerometer.

### Alternate Description

The present invention provides a way to build a fluid level sensor system which accurately provides fluid level information to the operator, without requiring an intrusion into the tank in the form of a resistive float sender or a capacitive sender. The invention provides immediate alarms to the operator in the event of miss-fueling errors, and may be used to increase safety of flight thereof as a result, and also to substantially reduce liability on the part of the vehicle manufacturer, as certain operator miss-fueling errors may be alarmed and logged. The invention also potentially reduces system weight (as fluid level sensors may be lighter than either capacitive or resistive senders) and increases reliability (as there are no moving parts in comparison to resistive senders) and increases immunity to water born contamination in fuel level determination (as capacitive senders fail to function when sufficient water is present.)

What is claimed is:

1. A pressure sensor system for determining fluid level in a tank, comprising:
a pressure sensor constructed to exhibit a force value corresponding to a sensed force;
a computer operatively coupled thereto;
a tank containing fluid;
a communication link between the pressure sensor and the tank, thereby allowing determination of the level of fluid in the tank by calibration and interpretation of the force value exhibited by the pressure sensor.
